(19) United States
(12) Patent Application Publication
(10) Pub. No.: US 2023/0364575 A1
(43) Pub. Date: Nov. 16, 2023

(54) CHEMICAL FEED DISTRIBUTORS AND METHODS OF USING THE SAME

(71) Applicant: Dow Global Technologies LLC, Midland, MI (US)

(72) Inventors: Matthew T. Pretz, Freeport, TX (US); Quan Yuan, Lake Jackson, TX (US); Pritish M. Kamat, Lake Jackson, TX (US); Liwei Li, Freeport, TX (US); Lin Luo, Freeport, TX (US)

(73) Assignee: Dow Global Technologies LLC, Midland, MI (US)

(21) Appl. No.: 18/246,949

(22) PCT Filed: Sep. 30, 2021
(86) PCT No.: PCT/US2021/052817

§ 371 Date: Mar. 28, 2023

Related U.S. Application Data
(60) Provisional application No. 63/085,264, filed on Sep. 30, 2020.

(51) Int. Cl. B01J 8/18; B01J 8/00; B01J 8/44

(52) U.S. Cl. CPC B01J 8/1827; B01J 8/0085; B01J 8/44; B01J 2208/00902; B01J 2208/00911

(57) ABSTRACT

According to one or more embodiments, a chemical feed distributor may include a chemical feed inlet, a body, a plurality of primary chemical feed outlets, and a secondary chemical feed outlet. The chemical feed inlet may pass a chemical feed stream into the chemical feed distributor. One or more walls of the body may define an elongated chemical feed stream flow path. The plurality of primary chemical feed outlets may be spaced along at least a portion of the length of the elongated chemical feed stream flow path and may be operable to pass a first portion of the chemical feed stream out of the feed distributor and into a vessel. The secondary chemical feed outlet may be downstream of the plurality of primary chemical feed outlets and may be operable to pass a second portion of the chemical feed stream out of the chemical feed distributor.

### CROSS-REFERENCE TO RELATED APPLICATIONS

The present application claims priority to U.S. Provisional Patent Application No. 63/085,264, filed Sep. 30, 2020, and entitled “CHEMICAL FEED DISTRIBUTORS AND METHODS OF USING THE SAME,” the entirety of which is incorporated by reference herein.

### BACKGROUND

### Field

The present specification generally relates chemical processing and, more specifically, to systems and processes for introducing chemical feed streams.

### Technical Background

Gaseous chemicals may be fed into reactors or other vessels through feed distributors. Feed distributors may be utilized to promote balanced distribution of a feed chemical stream into such reactors or vessels. Such distribution of feed chemicals may promote preferred reactions and may maintain mass transport equilibriums in chemical systems.

### SUMMARY

In a number of chemical processes, chemical feed streams are fed through chemical feed distributors into a hot environment, such as a reactor or a combustor. These hot environments may elevate the circumferential maximum surface temperature of the chemical feed distributors and may increase the risk of formation of carbonaceous deposits, referred as coking thereafter. This is particularly problematic in fluidized bed vessels, where fluidized solids in the vessel greatly enhances the heat transfer from the hot environment to the feed distributor through radiative and conductive heat transfer. In turn, the coking may create a risk of plugging and flow maldistribution. Accordingly, there is a need for improved chemical feed distributors. It has been found that chemical feed distributors which distribute only a portion of the chemical feed stream into the vessel, where another portion of the chemical feed stream is not fed into the vessel, may promote reduced peak surface temperatures on the chemical feed distributor. Embodiments of such chemical feed distributors are described herein. One or more embodiments of such chemical feed distributors may maintain a relatively steady circumferential maximum surface temperature and, therefore, reduce the risk of coking and the side effects associated with coking. Embodiments of the present disclosure meet this need by utilizing a chemical feed distributor with chemical feed stream recirculation, such that linear velocity may be maintained and stagnant zones within the chemical feed distributor may be reduced.

According to one embodiment, a chemical feed distributor may comprise a chemical feed inlet, a body, and a secondary chemical feed outlet. The chemical feed inlet may pass a chemical feed stream into the chemical feed distributor. The chemical feed stream may consist of a first portion and a second portion. The body may comprise one or more walls and a plurality of primary chemical feed outlets. The one or more walls may define an elongated chemical feed stream flow path. The plurality of primary chemical feed outlets may be spaced along at least a portion of the length of the elongated chemical feed stream flow path. The plurality of primary chemical feed outlets may be operable to pass the first portion of the chemical feed stream out of the feed distributor and into a vessel. The secondary chemical feed outlet may be downstream of the plurality of primary chemical feed outlets. The secondary chemical feed outlet may be operable to pass the second portion of the chemical feed stream out of the chemical feed distributor such that the second portion of the chemical feed stream is passed through the chemical feed distributor and does not enter the vessel.

According to another embodiment, a method for distributing a chemical feed stream may comprise passing a chemical feed stream through a chemical feed inlet into a chemical feed distributor. The chemical feed stream may consist of a first portion and a second portion. The method may also comprise passing the first portion of the chemical feed stream out of the chemical feed distributor through a plurality of primary chemical feed outlets and into a vessel. The method may further comprise passing the second portion of the chemical feed stream out of the chemical feed distributor through a secondary chemical feed outlet downstream of the plurality of primary chemical feed outlets such that the second portion of the chemical feed stream does not enter the vessel.

Additional features and advantages will be set forth in the detailed description which follows, and in part will be readily apparent to those skilled in the art from that description or recognized by practicing the embodiments described herein, including the detailed description which follows and the claims.

It is to be understood that both the foregoing general description and the following detailed description describe various embodiments and are intended to provide an overview or framework for understanding the nature and character of the claimed subject matter.

### BRIEF DESCRIPTION OF THE DRAWINGS

FIG. 1A is a schematic illustration of a cross-sectional overhead view of a chemical feed distributor in accordance with one or more embodiments of the present disclosure;

FIG. 1B is a schematic illustration of an perspective view of a first embodiment of a chemical feed distributor in accordance with one or more embodiments of the present disclosure;

FIG. 1C is a schematic illustration of a cross-sectional overhead view of a second embodiment of a chemical feed distributor in accordance with one or more embodiments of the present disclosure;

FIG. 1D is a schematic illustration of a cross-sectional overhead view of a third embodiment of a chemical feed distributor in accordance with one or more embodiments of the present disclosure;

FIG. 1E is a schematic illustration of a cross-sectional view of chemical feed outlets of a chemical feed distributor in accordance with one or more embodiments of the present disclosure;

FIG. 2 is a schematic cutaway view of a vessel in accordance with one or more embodiments of the present disclosure;

FIG. 3A is a schematic illustration of a model of the circumferential maximum surface temperature of the chemical feed distributor with feed recirculation in accordance with one or more embodiments of the present disclosure;

FIG. 3B is a schematic illustration of a model of the circumferential maximum surface temperature of the chemical feed distributor without feed recirculation in accordance with one or more embodiments of the present disclosure;

FIG. 4 is a graphical depiction of the peak temperature of a wall of a chemical feed distributor exposed to a chemical feed as a function of distance along the chemical feed distributor in accordance with one or more embodiments of the present disclosure; and

FIG. 5 is a graphical depiction of the normalized flow rate per nozzle as a function of nozzle distance from inlet along the chemical feed distributor in accordance with one or more embodiments of the present disclosure.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

The present disclosure is directed, according to one or more embodiments described herein, towards chemical feed distributors and methods for using such. Generally, the chemical feed distributors described herein may comprise a chemical feed inlet, a body comprising one or more walls, a plurality of primary chemical feed outlets, and a secondary feed outlet. A chemical feed stream may be passed through the chemical feed inlet. The chemical feed steam, as described herein, generally includes only a first portion and a second portion, which are equivalent in composition. A first portion of the chemical feed stream may be passed out of the plurality of primary chemical feed outlets, and the second portion may be passed out of the secondary chemical feed outlet.

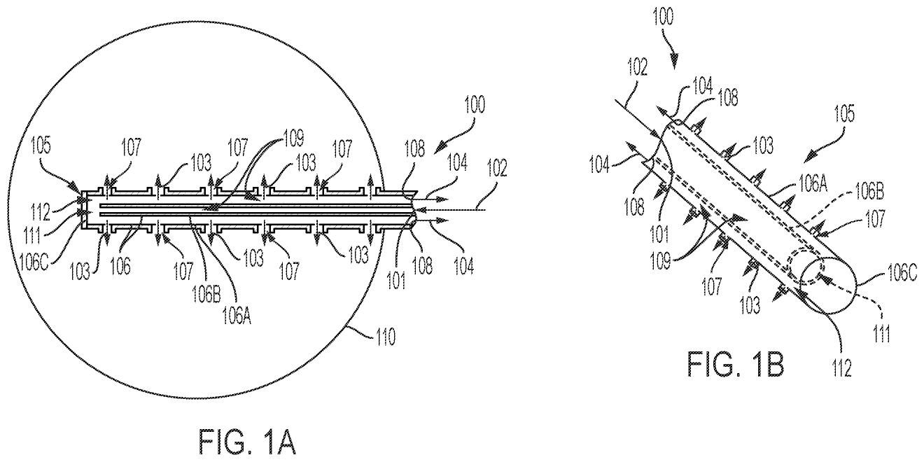

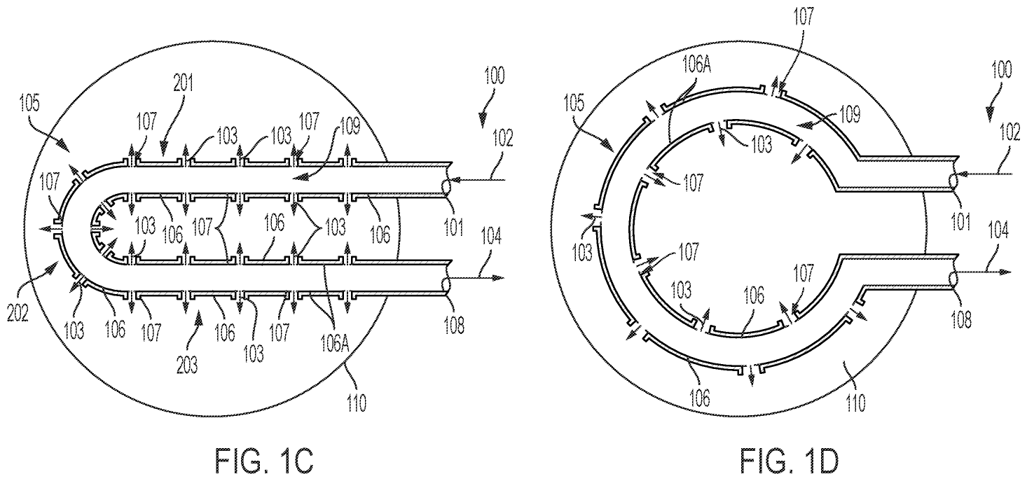

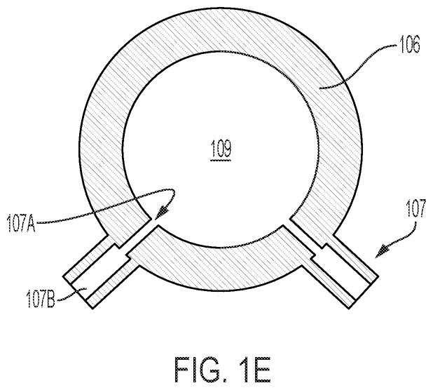

Numerous embodiments of chemical feed distributors are described with respect to the appended drawings. However, as presently described, these embodiments may share common themes such as the passing of the chemical feed stream through primary and secondary chemical feed stream outlets. For example, FIGS. 1A, 1B, 1C, and 1D each depict embodiments that similarly include primary and secondary chemical feed outlets.

Referring now to FIGS. 1A, 1B, 1C, and 1D, according to one or more embodiments, the chemical feed distributor 100 may comprise a chemical feed inlet 101. The chemical feed inlet 101 may pass a chemical feed stream 102 into the chemical feed distributor 100. Accordingly, the chemical feed stream 102 may pass through the chemical feed inlet 101 into the chemical feed distributor 100. As described herein, the chemical feed inlet 101 may refer to a place of entry in a vessel 110 that allows the chemical feed distributor 100 and the chemical feed stream 102 within the chemical feed distributor 100 to pass into the vessel 110.

The chemical feed distributor 100 may comprise a body 105. The body 105 may comprise one or more walls 106. The body 105 may also comprise a plurality of primary chemical feed outlets 107. As described herein, the plurality of primary chemical feed outlets 107 may be openings in the or more walls 106 of the body 105 and may provide a passage for the chemical feed stream 102 from the chemical feed distributor 100 to the vessel 110. In embodiments, the plurality of chemical feed outlets 107 may be arrange in a singular row along the chemical feed distributor. In other embodiments, as shown in FIG. 1B, the plurality of chemical feed outlets 107 may be arrange in an alternating position along the chemical feed distributor 100, such as two rows. It is contemplated that the chemical feed outlets 107 may be arrange in any configuration along the chemical feed distributor 100. The plurality of chemical feed outlets 107 may comprise orifices 107A at the start of each chemical feed outlet 107 to create pressure drop and create more even distribution. The plurality of chemical feed outlets 107 may also comprise diffusers 107B to slow the superficial gas velocity passing through the plurality of chemical feed outlets 107 so as not to cause catalyst attrition or chemical feed distributor 100 damage. The diffusers 107B may permit the gas velocity to be in a range from 50 feet per second (ft/sec) to 300 ft/sec.

The one or more walls 106 may define an elongated chemical feed stream flow path 109. The plurality of primary chemical feed outlets 107 may be spaced along at least a portion of the length of the elongated chemical feed stream flow path 109. The plurality of primary chemical feed outlets 107 may be operable to pass the first portion 103 of the chemical feed stream 102 out of the chemical feed distributor 100 and into a vessel 110. A secondary chemical feed outlet 108 may be downstream of the plurality of primary chemical feed outlets 107. The secondary chemical feed outlet 108 may be operable to pass the second portion 104 of the chemical feed stream 102 out of the chemical feed distributor 100. The second portion 104 of the chemical feed stream 102 may be passed through the chemical feed distributor 100 and may not enter the vessel 110. As used herein, the secondary chemical feed outlet 108 may refer to a place of exit in the vessel 110 that allows the chemical feed distributor 100 and any remaining portion of the chemical feed stream 102 within the chemical feed distributor 100 to pass out of the vessel 110. The remaining portion of the chemical feed stream 102 that may pass through the secondary chemical feed outlet 108 may correspond to the portion of the chemical feed stream 102 that is not passed from the chemical feed distributor 100 to the vessel 110 via the plurality of primary chemical feed outlets 107.

During operation, the chemical feed stream 102 may be fed at a relatively cool temperature compared to the temperature inside the vessel 110. According to one or more embodiments, the differential between the temperature of the chemical feed stream 102 and the temperature inside the vessel 110 may greater than 300° C., such as greater than 350° C., greater than 400° C., greater than 450° C., greater than 500° C., greater than 550° C., greater than 600° C., or greater than 650° C. In embodiments, the temperature inside the vessel 110 may be greater than 500° C. and the temperature of the chemical feed stream 102 may be lower than the temperature inside the vessel. During operation, the temperature inside the vessel 110 may begin to heat the chemical feed distributor 100 and, therefore, may elevate the circumferential maximum surface temperature of the chemical feed distributor 100. Circumferential maximum surface temperature may refer to the highest surface temperature throughout the chemical feed distributor 100. This may also elevate the temperature of the chemical feed stream 102 within the chemical feed distributor 100. If the circumferential maximum surface temperature of the chemical feed distributor 100 or the temperature of the chemical feed stream 102 inside the chemical feed distributor 100 increases too much, the chemical feed stream 102 may begin to deposit coke on the chemical feed distributor 100. When coke deposits on the chemical feed distributor 100, plugging may begin at the plurality of primary chemical feed outlets 107, which could result in flow maldistribution, which may result in operational issues. As used in the present disclosure, “flow maldistribution” may refer to differences in uniform flow distribution between the plurality of primary chemical feed outlets 107.

According to one or more embodiments of the present disclosure, the secondary chemical feed outlet 108 may be downstream of the plurality of primary chemical feed outlets 107. The secondary chemical feed outlet 108 may be operable to pass the second portion 104 of the chemical feed stream 102 out of the chemical feed distributor 100. Passing the second portion 104 of the chemical feed stream 102 out of the chemical feed distributor 100 may decrease the risk of coking, and, in turn, the risk of plugging and flow maldistribution. Without being bound to any particular theory, the total flow rate of the chemical feed stream 102 in the chemical feed distributor 100 may be increased as the second portion 104 of the chemical feed stream 102 is passed out of the chemical feed distributor 100 and not actually entering the vessel 110. This increased flow rate of the chemical feed stream 102 may not substantially effect the flow rate of chemical feed stream 102 entering the vessel 110, as the first portion 103 of the chemical feed stream 102, may remain the same as if there was no recirculation of the second portion 104 of the chemical feed stream 102. Without being bound to any particular theory, this increased flow rate of the chemical feed stream 102 may reduce stagnation in the chemical feed distributor 100. This reduction in stagnation may result in maintaining a desirable Reynolds number where the chemical feed stream 102 within the chemical feed distributor 100 is rapidly moving through the chemical feed distributor 100. With an increased flow of the chemical feed stream 102 within the chemical feed distributor 100, the circumferential maximum surface temperature of the chemical feed distributor 100 may remain low enough such that coking may be minimized. That is, this desirable Reynolds number may effectively minimize coking, and, in turn, plugging of the plurality of primary chemical feed outlets 107 and flow maldistribution.

As used in this disclosure, a “chemical feed” may refer to any process feed stream or fuel gas, such as, but not limited to, methane, natural gas, ethane, propane, hydrogen, or any gas that comprises energy value upon combustion. Additionally, as used in this disclosure, a “vessel” may refer to a hollow container for holding a gas or solids, such as, a reactor or combustor in which one or more chemical reactions may occur between one or more reactants optionally in the presence of one or more catalysts. The vessel may have a solid particle volume fraction up to 55 vol. % and the superficial velocity of the gas in the vessel may be higher than the minimum fluidization velocity of the solid particles.

As used in this disclosure, the terms “upstream” and “downstream” may refer to the relative positioning of elements with respect to the direction of flow of the process streams. A first element of a system may be considered “upstream” of a second element if process streams flowing through the system encounter the first element before encountering the second element. Likewise, a second element may be considered “downstream” of the first element if the process streams flowing through the system encounter the first element before encountering the second element.

Additionally, as used in the present disclosure “coking” may refer to the formation of carbonaceous deposits, or coke. “Plugging” may refer to an accumulation of coke such that a passage or port may be partially restricted or completely blocked.

Referring to FIGS. 1A and 1B, in some embodiments, the one or more walls 106 may define an upstream fluid passage 111 and a downstream fluid passage 112 of the elongated chemical feed stream flow path 109. The upstream fluid passage 111 may be in fluid communication with the chemical feed inlet 101. The upstream fluid passage 111 may be in fluid communication with the downstream fluid passage 112. The downstream fluid passage 112 may be in fluid communication with the plurality of primary chemical feed outlets 107 and with the secondary chemical feed outlet 108.

According to one or more embodiments, the upstream fluid passage 111 may be separated from the downstream fluid passage 112 by one or more walls 106. A first wall 106A may define the upstream fluid passage 111. A second wall 106B, in conjunction with the first wall 106A, may define the downstream fluid passage 112. A third wall 106C may serve as an end of the chemical feed distributor 100. The third wall 106C may be perpendicular to the first wall 106A and second wall 106B. It is contemplated that the third wall 106C may also comprise other geometries. The third wall 106C may be linear, rounded, or pointed. For the upstream fluid passage 111 to be in fluid communication with the downstream fluid passage 112, the body 105 of the chemical feed distributor 100 may comprise a void between the end of the first wall 106A and the third wall 106C. The void between the end of the first wall 106A and the third wall 106C may allow the chemical feed stream 102 to fluidly pass from the upstream fluid passage 111 to the downstream fluid passage 112.

According to one or more embodiments, the downstream fluid passage 112 may surround the upstream fluid passage 111. In some embodiments, the downstream fluid passage 112 may be completely surrounded by the upstream fluid passage 111. In other embodiments, a wall 106 of the downstream fluid passage 112 may be in contact with a wall 106 of the upstream fluid passage 111, such that the downstream fluid passage 112 does not completely surround the upstream fluid passage 111. The downstream fluid passage 112 and upstream fluid passage 111 may comprise any combination of various geometries. For example, the upstream fluid passage 111 may comprise a cylindrical or rectangular shape. The downstream fluid passage 112 may comprise a cylindrical shell or rectangular shell shape surrounding the cylindrical shape. The downstream fluid passage 112 may comprise a shell (i.e., a hollow geometry) as the downstream fluid passage 112 may partially or completely surround the upstream fluid passage 111. Similarly, the upstream fluid passage 111 may, for example, comprise a circular, rectangular, or trapezoidal cross-sectional shape. The downstream fluid passage 112 may comprise a circular shell, rectangular shell, or trapezoidal shell cross-sectional shape. It is contemplated that, in embodiments, the downstream fluid passage 112 may not necessarily comprise a shell or hollow geometry. In embodiments, the downstream fluid passage 112 may not surround the upstream fluid passage 111. Thus, in embodiments, the downstream fluid passage 112 may comprise a cylindrical, rectangular, circular, or trapezoidal shape.

According to one or more embodiments, the upstream fluid passage 111 and the downstream fluid passage 112 may form a co-axial geometry. In other embodiments, the upstream fluid passage 111 and the downstream fluid passage 112 may form an off-center geometry. Said differently, the upstream fluid passage 111 and the downstream fluid passage 112 may be concentric or eccentric. According to one or more embodiments, the upstream fluid passage 111 may be hermetic. That is, the upstream fluid passage 111 may be airtight such that the upstream fluid passage 111 does not combine with the downstream fluid passage 112 until the point of where the upstream fluid passage 111 is in fluid communication with the downstream fluid passage 112.

Referring to FIG. 1C, according to one or more embodiments, the body 105 may consist of a tube. As previously discussed, the body 105 may be defined by one or more walls 106. The one or more walls 106 may define a first straight tube segment 120, a connector tube segment 121, and a second straight tube segment 122. The first straight tube segment 120 may be connected to the chemical feed inlet 101. The first straight tube segment 120 may also be connected to the connector tube segment 121. The connector tube segment 121 may be connected to the first straight tube segment 120 and the second straight tube segment 122. The second straight tube segment 122 may be connected to the secondary chemical feed outlet 108. Together, the first straight tube segment 120, the connector tube segment 121, and the second straight tube segment 122 may define the elongated chemical feed stream flow path 109. The chemical feed stream 102 may enter the first straight tube segment 120 through the chemical feed inlet 101. The chemical feed stream 102 may pass through the first straight tube segment 120, the connector tube segment 121, and the second straight tube segment 122. The first portion 103 of the chemical feed stream 102 may enter the vessel 110 through the plurality of primary chemical feed outlets 107. As previously discussed, the plurality of primary chemical feed outlets 107 may be spaced along the length of the elongated chemical feed stream flow path 109. The second portion 104 of the chemical feed stream 102 may remain in the chemical feed distributor 100, such that it does not pass into the vessel 110. The second portion 104 of the chemical feed stream 102 may exit the chemical feed distributor 100 via the secondary chemical feed outlet 108.

According to one or more embodiments, the first straight tube segment 120 and the second straight tube segment 122 may be substantially parallel. In some embodiments, the connector tube segment 121 may be U-shaped (such that the connector tube segment 121 comprises a 180° bend). In such an embodiment, the first straight tube segment 120 and the second straight tube segment 122 may be parallel. It is contemplated that, in some embodiments, a plurality of connector tube segments 121 may be used such that the chemical feed distributor 100 comprises a plurality of first straight tube segments 120 and a plurality of second straight tube segments 122 between the chemical feed inlet 101 and secondary chemical feed outlet 108.

Referring to FIG. 1D, according to one or more embodiments, the body 105 may be shaped to have a contour which substantially follows the vessel 110 perimeter. In some embodiments, the vessel 110 may be substantially circular. Accordingly, the body 105 may comprise a circular or ring shape. The first wall 106A may define the elongated chemical feed stream flow path 109. The first wall 106A may comprise a plurality of primary chemical feed outlets 107, as previously detailed herein. As previously described with respect to FIGS. 1A, 1B, and 1C, the chemical feed stream 102 may enter the chemical feed distributor 100 via the chemical feed inlet 101. The chemical feed stream 102 may travel along the elongated chemical feed stream flow path 109 of the chemical feed distributor 100. The first portion 103 of the chemical feed stream 102 may enter the vessel 110 through the plurality of primary chemical feed outlets 107. The second portion 104 of the chemical feed stream 102 may remain in the chemical feed distributor 100, such that it does not pass into the vessel 110. The second portion 104 of the chemical feed stream 102 may exit the chemical feed distributor 100 via the secondary chemical feed outlet 108.

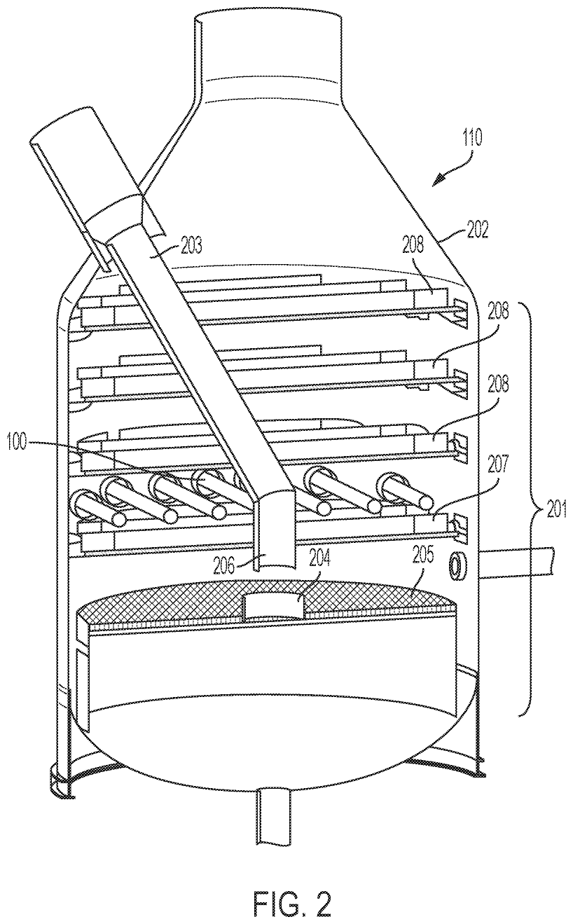

Referring to FIG. 2, a schematic cutaway view of an embodiment of a vessel 110 is shown. FIG. 2 shows a vessel 110 used as a fluidized fuel gas combustor system for a catalytic dehydrogenation process. However, as detailed herein, the chemical feed distributor 100 may be employed in a variety of vessels 110. Referring again to FIG. 2, the vessel 110 may include a lower portion 201 generally in the shape of a cylinder and an upper portion comprising a frustum 202. The angle between the frustum 202 and an internal horizontal imaginary line drawn at the intersection of the frustum 202 and the lower portion 201 may range from 10 to 80 degrees. All individual values and subranges from 10 to 80 degrees are included and disclosed herein; for example the angle between the tubular and frustum 202 components can range from a lower limit of 10, 40 or 60 degrees to an upper limit of 30, 50, 70 or 80 degrees. For example, the angle can be from 10 to 80 degrees, or in the alternative, from 30 to 60 degrees, or in the alternative, from 10 to 50 degrees, or in the alternative, from 40 to 80 degrees. Furthermore, in alternative embodiments, the angle can change along the height of the frustum 202, either continuously or discontinuously. In some embodiments, the vessel 110 may be, or may not be, lined with a refractory material.

Spent or partially deactivated catalyst may enter the vessel 110 through downcomer 203. In alternative configurations, the spent or partially deactivated catalyst may enter the vessel 110 from a side inlet or from a bottom feed, passing upward through the air distributor as described in U.S. Pat. No. 9,370,759 B2. The used catalyst impinges upon and is distributed by splash guard 204. The vessel 110 may further includes air distributors 205 which are located at or slightly below the height of the splash guard 204. Above the air distributors 205 and the outlet 206 of downcomer 203 may be a grid 207. Above the grid 207 may be a plurality of chemical feed distributors 100. One or more additional grids 208 may be positioned within the vessel 110 above the chemical feed distributors 100. In embodiments, the chemical feed distributors 100 may enter the vessel 110 and traverse substantially across the vessel 110 as described in U.S. patent application Ser. No. 14/868,507.

As previously described herein, according to one or more embodiments, the method for distributing the chemical feed stream 102 may comprise passing the chemical feed stream 102 through the chemical feed inlet 101 into the chemical feed distributor 100. The chemical feed stream 102 may consist of the first portion 103 and the second portion 104. The method may also comprise passing the first portion 103 of the chemical feed stream 102 out of the chemical feed distributor 100. The first portion 103 of the chemical feed stream 102 may pass through the plurality of primary chemical feed outlets 107 and into the vessel 110. The method may further comprise passing the second portion 104 of the chemical feed stream 102 out of the chemical feed distributor 100 through the secondary chemical feed outlet 108. As previously described herein, the secondary chemical feed outlet 108 may be downstream of the plurality of primary chemical feed outlets 107. Accordingly, the second portion 104 of the chemical feed stream 102 may not enter the vessel 110.

According to another embodiment, the method for distributing the chemical feed stream 102 may comprise passing the chemical feed stream 102 through the chemical feed inlet 101 into the chemical feed distributor 100. Again, the chemical feed stream 102 may consist of the first portion 103 and the second portion 104. The chemical feed distributor 100 may comprise a body 105 comprising one or more walls 106. The one or more walls 106 may define the elongated chemical feed stream flow path 109 and the plurality of primary chemical feed outlets 107. The plurality of primary chemical feed outlets 107 may be spaced along at least a portion of the length of the elongated chemical feed stream flow path 109. The method may also comprise passing the first portion 103 of the chemical feed stream 102 along the elongated chemical feed stream flow path 109. The first portion 103 of the chemical feed stream 102 may pass through the plurality of primary chemical feed outlets 107 out of the chemical feed distributor 100 and into the vessel 110. The method may further comprise passing the second portion 104 of the chemical feed stream 102 out of the chemical feed distributor 100 through the secondary chemical feed outlet 108. The second portion 104 of the chemical feed stream 102 may be passed through the chemical feed distributor 100 and may not enter the vessel 110.

According to some embodiments, the flow rates of the chemical feed stream 102, the first portion 103 of the chemical feed stream 102, and the second portion 104 of the chemical feed stream 102 may be represented by a series of expressions. The flow rate of the chemical feed stream 102, Cᵢ, may be represented by Equation 1. The flow rate of the first portion 103 of the chemical feed stream 102, C₁, may be represented by Equation 2. The flow rate of the second portion 104 of the chemical feed stream 102, C₂, may be represented by Equation 3, as shown below:

Cᵢ=(1+r)X (Equation 1)

C₁=X (Equation 2)

C₂=rX (Equation 3)

In Equations 1, 2, and 3, as shown above, r is the ratio of the flow rate of the second portion 104 of the chemical feed stream 102 to the flow rate of the first portion 103 of the chemical feed stream 102 and X is the nominal flow rate (that is, the flow rate of the portion of the chemical feed stream 102 (the first portion 103) that passes out of the chemical feed distributor 100 and into the vessel 110).

In embodiments, the ratio of the flow rate of the second portion 104 of the chemical feed stream 102 to the flow rate of the first portion 103 of the chemical feed stream 102 may be from 0.1 to 3.0. For example, the ratio of the flow rate of the second portion 104 of the chemical feed stream 102 to the flow rate of the first portion 103 of the chemical feed stream 102 may be from 0.1 to 0.5, from 0.1 to 1.0, from 0.1 to 1.5, from 0.1 to 2.0, from 0.1 to 2.5, from 0.5 to 1.0, from 0.5 to 1.5, from 0.5 to 2.0, from 0.5 to 2.5, from 0.5 to 3.0, from 1.0 to 1.5, from 1.0 to 2.0, from 1.0 to 2.5, from 1.0 to 3.0, from 1.5 to 2.0, from 1.5 to 2.5, from 1.5 to 3.0, from 2.0 to 2.5, from 2.0 to 3.0, or from 2.5 to 3.0.

In some embodiments, the ratio of the flow rate of the second portion 104 of the chemical feed stream 102 to the flow rate of the first portion 103 of the chemical feed stream 102 may be from 0.5 to 1.5. For example, the ratio of the flow rate of the second portion 104 of the chemical feed stream 102 to the flow rate of the first portion 103 of the chemical feed stream 102 may be from 0.5 to 0.7, from 0.5 to 0.9, from 0.5 to 1.1, from 0.5 to 1.3, from 0.7 to 0.9, from 0.7 to 1.1, from 0.7 to 1.3, from 0.7 to 1.5, from 0.9 to 1.1, from 0.9 to 1.3, from 0.9 to 1.5, from 1.1 to 1.3, from 1.1 to 1.5, or from 1.3 to 1.5.

According to one or more embodiments, the method may further comprise recycling the second portion 104 of the chemical feed stream 102. The second portion 104 of the chemical feed stream 102 that passes out of the chemical feed distributor 100 may be combined with the chemical feed stream 102 prior to the chemical feed stream 102 passing through the chemical feed inlet 101.

According to one or more embodiments, the temperature inside the vessel 110 may be greater than 650° C. and the circumferential maximum surface temperature of the chemical feed distributor 100 may not exceed the temperature inside the vessel 100. In other embodiments, the temperature inside the vessel 110 may be greater than 650° C. and the circumferential maximum surface temperature of the chemical feed distributor 100 may not exceed 650° C.

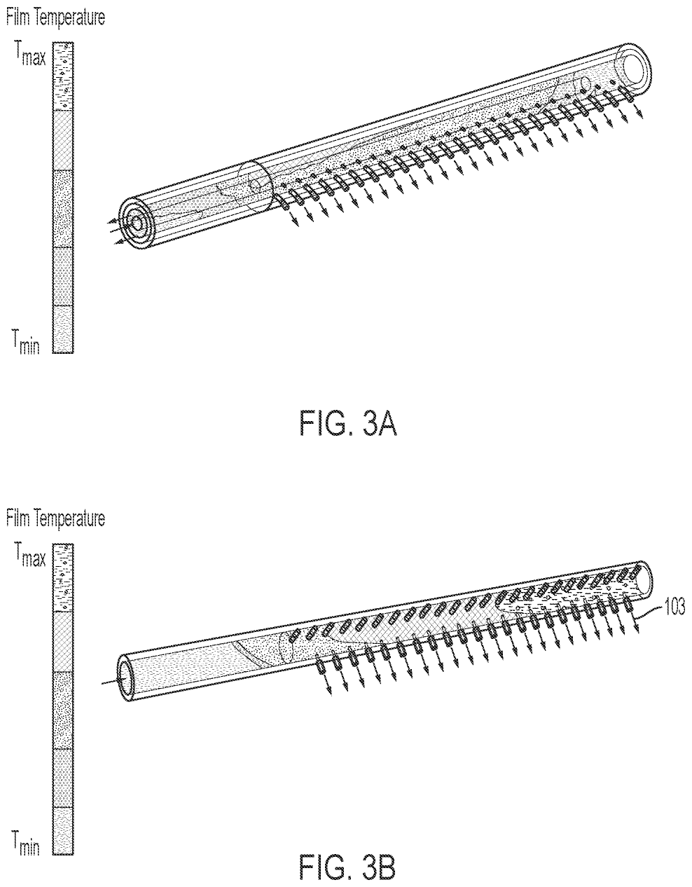

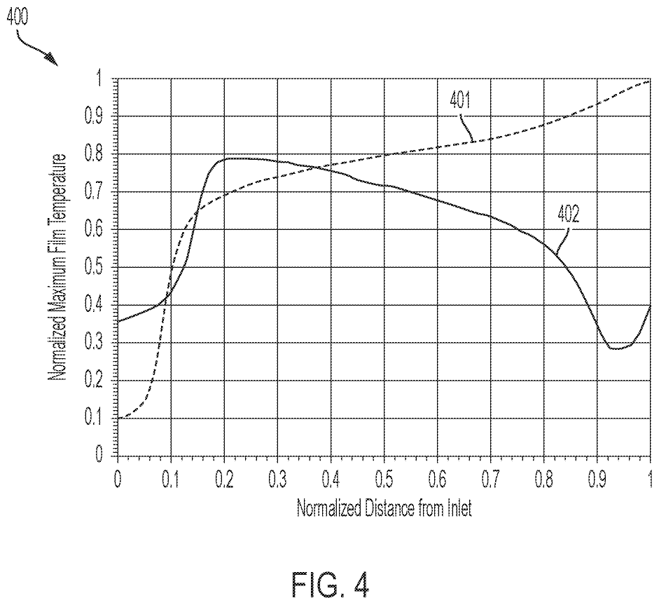

As further discussed below, FIGS. 3A, 3B, and 4 further demonstrate the circumferential maximum surface temperature and peak surface temperature of the chemical feed distributor 100 according to embodiments described herein.

As previously described herein, the chemical feed distributor 100 of the embodiments herein may reduce the risk of coking. As coking may create a risk of plugging and flow maldistribution, the chemical feed distributor 100 of the embodiments herein may reduce the risk of plugging and flow maldistribution. Flow maldistribution may also be caused by the heating up of the chemical feed stream 102 within the chemical feed distributor 100, which may be referred to as thermally-induced flow maldistribution. As the temperature of the chemical feed stream 102 within the chemical feed distributor 100 increases, the density of the chemical feed stream 102 may decrease. Mass flow rate is proportional to the square root of the gas density. If the density of the chemical feed stream 102 decreases along a length of the chemical feed distributor 100, the mass flow rate may also decrease along the length of the chemical feed distributor 100. However, according to one or more embodiments of the present disclosure, the temperature increase of the chemical feed stream 102 may be lower, which in turn decreases any change in the density of the chemical feed stream 102. Therefore, the thermally-induced flow maldistribution may be decreased.

In embodiments of the present disclosure, the relative reduction in flow maldistribution (including thermally-induced flow maldistribution) may be less than ±15.0%, such as less than ±14.5%, less than 14.0%, less than ±13.5%, less than ii 13.0%, less than ±12.5%, less than ±12.0%, less than ±11.5%, less than ±11.0%, less than +10.5%, less than ±10.0%, less than ±9.5%, less than 9.0%, less than ±8.5%, less than ±8.0%, less than 7.5%, less than ±7.0%, less than ±6.5%, less than ±6.0%, less than ±5.5%, less than ±5.0%, less than +4.5%, less than ±4.0%, less than 3.5%, less than 3.0%, or less than ±3.0%. Flow maldistribution may be determined using a computational fluid dynamics (CFD) program ANSYS Fluent® which can numerically predict the 3D compressible flow and conjugated heat transfer in the system following the first principle mass, momentum and energy conservation laws. The flow maldistribution is simply the deviation from a perfect average mass distribution at various points along the distributor.

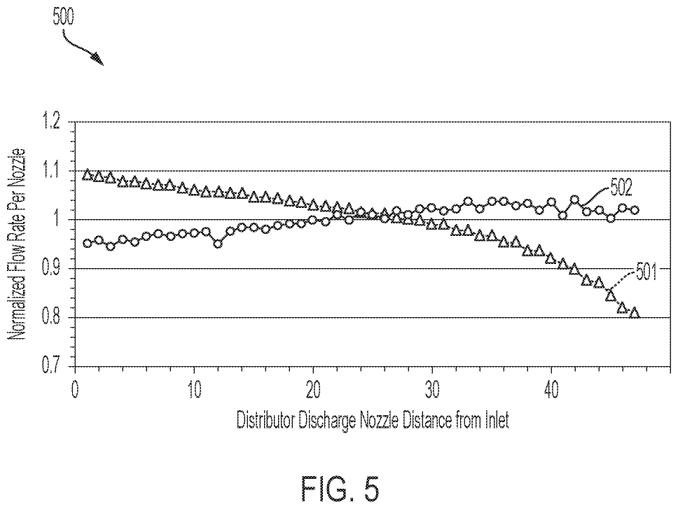

As shown in FIG. 5, the embodiments of the present disclosure, where a second portion 104 of the chemical feed stream 102 is passed out of the chemical feed distributor 100, demonstrate a decreased flow maldistribution as compared to an embodiment where a second portion 104 of the chemical feed stream 102 is not passed out of the chemical feed distributor 100. In fact, the flow maldistribution of the present embodiments may be less than ±7.5%. Conversely, the flow maldistribution of an embodiment where a second portion 104 of the chemical feed stream 102 is not passed out of the chemical feed distributor 100 may be as high as 30.0%, as shown in FIG. 5.

### EXAMPLES

The various embodiments of systems and processes for distributing a chemical feed through a chemical feed distributor will be further clarified by the following examples. The examples are illustrative in nature, and should not be understood to limit the subject matter of the present disclosure.

### Example 1: Effect of Feed Recirculation

In Example 1, a computational fluid dynamic (CFD) model was used to compare a chemical feed distributor with feed recirculation to a chemical feed distributor without feed recirculation. A gas stream comprising methane, ethylene, and propylene was fed into the chemical feed distributors at 52° C. The chemical feed distributors then directed the gas stream into a fluidized bed reactor operating at 730° C. Both chemical feed distributors have the same gas stream flow rate. However, in the chemical feed distributor with feed recirculation, half of the gas stream was allowed to enter the fluidized bed reactor, while the remaining half of the gas stream was passed through the entirety of the chemical feed distributor and recirculated.

As shown in FIGS. 3 and 4, an embodiment according the present disclosure where a second portion of the chemical feed stream is passed out of the chemical feed distributor (FIG. 3A) is compared with an embodiment where a second portion of the chemical feed stream is not passed out of the chemical feed distributor (FIG. 3B). The peak surface temperatures of the feed stream at each of the chemical feed distributors internal wall surfaces were obtained from the CFD model. Compared to the chemical feed distributor without feed recirculation, the chemical feed distributor with feed recirculation demonstrates a lower peak surface temperature. As seen in FIG. 4, a distal end (the end opposite the chemical feed inlet) of the chemical feed distributor without feed recirculation is much hotter than that of the chemical feed distributor where a second portion of the chemical feed stream is passed out of the chemical feed distributor. FIG. 4 demonstrates a much more uniform temperature across the length of the chemical feed distributor where a second portion of the chemical feed stream is passed out of the chemical feed distributor (402), as compared to a chemical feed distributor where a second portion of the chemical feed stream is not passed out of the chemical feed distributor (401). Further, FIG. 4 demonstrates that the peak surface temperature that does not reach temperatures as high as an embodiment where a second portion of the chemical feed stream is not passed out of the chemical feed distributor (401). This lower peak surface temperature may be due to the second portion of the chemical feed stream that passes out of the chemical feed distributor. It will be apparent to those skilled in the art that the peak surface temperature may be adjusted based on the process needs by tuning the feed recirculation rate to reduce the risk of coking.

Additionally, as shown in FIG. 5, in embodiments of the present disclosure, the flow rate per primary chemical feed outlet across the chemical feed distributor is much more stable. That is, when a second portion of the chemical feed stream is passed out of the chemical feed distributor (502) when a second portion of the chemical feed stream is not passed out of the chemical feed distributor (501). As previously described herein, this may be attributable to the reduced flow maldistribution.

One or more aspect of the present disclosure are described herein. A first aspect may include a chemical feed distributor comprising: a chemical feed inlet that passes a chemical feed stream into the chemical feed distributor, the chemical feed stream consisting of a first portion and a second portion; a body comprising one or more walls and a plurality of primary chemical feed outlets, wherein the one or more walls define an elongated chemical feed stream flow path, wherein the plurality of primary chemical feed outlets are spaced along at least a portion of the length of the elongated chemical feed stream flow path, and wherein the plurality of primary chemical feed outlets are operable to pass the first portion of the chemical feed stream out of the feed distributor and into a vessel; and a secondary chemical feed outlet downstream of the plurality of primary chemical feed outlets, wherein the secondary chemical feed outlet is operable to pass the second portion of the chemical feed stream out of the chemical feed distributor such that the second portion of the chemical feed stream is passed through the chemical feed distributor and does not enter the vessel.

A second aspect may include the first aspect, wherein: the one or more walls define an upstream fluid passage and a downstream fluid passage of the elongated chemical feed stream flow path; the upstream fluid passage is in fluid communication with the chemical feed inlet; the upstream fluid passage is in fluid communication with the downstream fluid passage; and the downstream fluid passage is in fluid communication with the plurality of primary chemical feed outlets and with the secondary chemical feed outlet.

A third aspect may include the second aspect, wherein the upstream fluid passage is separated from the downstream fluid passage by one or more walls.

A fourth aspect may include either the second or third aspect, wherein the downstream fluid passage surrounds the upstream fluid passage.

A fifth aspect may include any of the second through fourth aspects, wherein the upstream fluid passage comprises a cylindrical shape, and the downstream fluid passage comprises a cylindrical shell shape surrounding the cylindrical shape.

A sixth aspect may include any of the second through fifth aspects, wherein the upstream fluid passage and the downstream fluid passage form a co-axial geometry.

A seventh aspect may include any of the second through sixth aspects, wherein the upstream fluid passage is hermetic.

An eighth aspect may include the first aspect, wherein the body consists of a tube.

A ninth aspect may include the eighth aspect, wherein the body comprises a first straight tube segment, a connector tube segment, and a second straight tube segment, wherein the first straight tube segment is connected to the connector tube segment, the connector tube segment is connected to the second straight tube segment, and the first straight tube segment and the second straight tube segment are substantially parallel.

A tenth aspect may include the first aspect, wherein the body is shaped to have a contour which substantially follows the vessel perimeter.

An eleventh aspect may include a method for distributing a chemical feed stream, the method comprising: passing a chemical feed stream through a chemical feed inlet into a chemical feed distributor, the chemical feed stream consisting of a first portion and a second portion; passing the first portion of the chemical feed stream out of the chemical feed distributor through a plurality of primary chemical feed outlets and into a vessel; and passing the second portion of the chemical feed stream out of the chemical feed distributor through a secondary chemical feed outlet downstream of the plurality of primary chemical feed outlets such that the second portion of the chemical feed stream does not enter the vessel.

A twelfth aspect may include the eleventh aspect, wherein the chemical feed distributor comprises a body comprising one or more walls defining an elongated chemical feed stream flow path and a plurality of primary chemical feed outlets spaced along at least a portion of the length of the elongated chemical feed stream flow path.

A thirteenth aspect may include either the eleventh or twelfth aspect, wherein the ratio of a flow rate of the second portion of the chemical feed stream to the flow rate of the first portion of the chemical feed stream is from 0.1 to 3.0.

A fourteenth aspect may include either the eleventh or twelfth aspect, further comprising recycling the second portion of the feed stream such that the second portion of the chemical feed stream that passes out of the chemical feed distributor is combined with the chemical feed stream prior to the chemical feed stream passing through the chemical feed inlet.

A fifteenth aspect may include either the eleventh or twelfth aspect, wherein the temperature inside the vessel is greater than 650° C. and the circumferential maximum surface temperature of the chemical feed distributor does not exceed 650° C.

Finally, it will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A chemical feed distributor comprising:
a chemical feed inlet that passes a chemical feed stream into the chemical feed distributor, the chemical feed stream consisting of a first portion and a second portion;
a body comprising one or more walls and a plurality of primary chemical feed outlets, wherein the one or more walls define an elongated chemical feed stream flow path, wherein the plurality of primary chemical feed outlets are spaced along at least a portion of the length of the elongated chemical feed stream flow path, and wherein the plurality of primary chemical feed outlets are operable to pass the first portion of the chemical feed stream out of the feed distributor and into a vessel; and
a secondary chemical feed outlet downstream of the plurality of primary chemical feed outlets, wherein the secondary chemical feed outlet is operable to pass the second portion of the chemical feed stream out of the chemical feed distributor such that the second portion of the chemical feed stream is passed through the chemical feed distributor and does not enter the vessel.

2. The chemical feed distributor of claim 1, wherein:
the one or more walls define an upstream fluid passage and a downstream fluid passage of the elongated chemical feed stream flow path;
the upstream fluid passage is in fluid communication with the chemical feed inlet;
the upstream fluid passage is in fluid communication with the downstream fluid passage; and
the downstream fluid passage is in fluid communication with the plurality of primary chemical feed outlets and with the secondary chemical feed outlet.

3. The chemical feed distributor of claim 2, wherein the upstream fluid passage is separated from the downstream fluid passage by one or more walls.

4. The chemical feed distributor of claim 2, wherein the downstream fluid passage surrounds the upstream fluid passage.

5. The chemical feed distributor of claim 2, wherein the upstream fluid passage comprises a cylindrical shape, and the downstream fluid passage comprises a cylindrical shell shape surrounding the cylindrical shape.

6. The chemical feed distributor of claim 2, wherein the upstream fluid passage and the downstream fluid passage form a co-axial geometry.

7. The chemical feed distributor of claim 2, wherein the upstream fluid passage is hermetic.

8. The chemical feed distributor of claim 1, wherein the body consists of a tube.

9. The chemical feed distributor of claim 8, wherein the body comprises a first straight tube segment, a connector tube segment, and a second straight tube segment, wherein the first straight tube segment is connected to the connector tube segment, the connector tube segment is connected to the second straight tube segment, and the first straight tube segment and the second straight tube segment are substantially parallel.

10. The chemical feed distributor of claim 1, wherein the body is shaped to have a contour which substantially follows the vessel perimeter.

11. A method for distributing a chemical feed stream, the method comprising:
passing a chemical feed stream through a chemical feed inlet into a chemical feed distributor, the chemical feed stream consisting of a first portion and a second portion;
passing the first portion of the chemical feed stream out of the chemical feed distributor through a plurality of primary chemical feed outlets and into a vessel; and
passing the second portion of the chemical feed stream out of the chemical feed distributor through a secondary chemical feed outlet downstream of the plurality of primary chemical feed outlets such that the second portion of the chemical feed stream does not enter the vessel.

12. The method of claim 11, wherein the chemical feed distributor comprises a body comprising one or more walls defining an elongated chemical feed stream flow path and a plurality of primary chemical feed outlets spaced along at least a portion of the length of the elongated chemical feed stream flow path.

13. The method of claim 11, wherein the ratio of a flow rate of the second portion of the chemical feed stream to the flow rate of the first portion of the chemical feed stream is from 0.1 to 3.0.

14. The method of claim 11, further comprising recycling the second portion of the feed stream such that the second portion of the chemical feed stream that passes out of the chemical feed distributor is combined with the chemical feed stream prior to the chemical feed stream passing through the chemical feed inlet.

15. The method of claim 11, wherein the temperature inside the vessel is greater than 650° C. and the circumferential maximum surface temperature of the chemical feed distributor does not exceed 650° C.
